(19) United States
(12) Patent Application Publication
(10) Pub. No.: US 2006/0135727 A1
(43) Pub. Date: Jun. 22, 2006

(54) Polymer dispersions in polyester polyols

(75) Inventors: Hartmut Nefzger, Pulheim (DE); Erika Bauer, Juchen (DE); Erhard Michels, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/302,030

(22) Filed: Dec. 13, 2005

(30) Foreign Application Priority Data
Dec. 18, 2004 (DE) 102004061103.3

(51) Int. Cl. C08G 18/00

(52) U.S. Cl. 528/44

(57) ABSTRACT

The present invention relates to polymer dispersions in polyester polyols, to a process for their preparation and to their use in the preparation of polyurethanes, and particularly microcellular polyurethanes. The polymer dispersions of the present invention comprise a polyester polyol containing structural units derived from succinic acid.

### CROSS-REFERENCE TO RELATED PATENT APPLICATION

The present patent application claims the right of priority under 35 U.S.C. § 119 (a)-(d) of German Patent Application No. 10 2004 061 103, filed Dec. 18, 2004.

### BACKGROUND OF THE INVENTION

The present invention relates to polymer dispersions in polyester polyols, to a process for their preparation and to their use in the preparation of polyurethanes, and particularly microcellular polyurethanes.

Dispersions of solid, high molecular weight polymers in polyols (i.e. polymer polyols) are frequently used in the production of flexible polyurethane foams. An advantage of this is, for example, that the open-cell nature of the foams is increased and the mechanical properties of the foams are improved as a result of the increased hardness. Mention may be made in this context of tear strength, tensile stress and compression set. As a result, it is possible to establish a reduced density while retaining the properties that are otherwise only achievable with a higher density. A significant saving in terms of material, and accordingly a reduction in costs, can be made as a result.

Dispersions of polymers in polyols are known in the literature, there being described, in addition to dispersions obtainable by reaction of olefin-group-containing monomers in polyols, also other types of dispersions such as, for example, those which are prepared from diamines and polyisocyanates. It likewise becomes clear that the polyols used are, in most cases, polyether polyols having molar masses of from 1000 to 10,000 g/mol., with polyester polyols being used more rarely. One reason for this may be the comparatively high viscosity of the polyester polyols themselves, and in particular, of dispersions based on polyester polyols, as compared with corresponding systems based on polyether polyols. Nevertheless, dispersions based on polyester polyols are of interest commercially, particularly because polyurethane systems produced therefrom exhibit mechanical properties that are better in many respects than those of the corresponding polyether-based polyurethanes.

Aqueous systems for the production of heat-curable stoving lacquers are disclosed in DE-OS 44 27 227. This reference describes the use of polyester polyols dispersed in water and filled with polymerisation products of olefinic monomers as one of the system components.

If styrene is used as the vinyl monomer in such systems, otherwise analogous dispersions are less stable on account of the lower reactivity of styrene compared with acrylonitrile, and the lower rate of chain transfer to many molecular species. Consequently, the use of styrene as a radically polymerisable vinyl monomer for the preparation of dispersions based on polyester polyols requires the incorporation of graft sites into or at the end of the polyester molecules. This is particularly true when only styrene is used as the vinyl monomer. Such graft sites must ensure the chain transfer of the radically growing polymer molecules with the formation of covalent bonds and, if possible, while retaining the growing radical chain.

Some examples of such modifications are given in EP-A 250 351. For example, the incorporation of maleic anhydride into the polyester polyol chain can fulfil this function. More specifically, EP-A 0 250 351 discloses a process in which at least one ethylenically unsaturated monomer is polymerised in a polyester polyol having a molar mass of from 1000 to 5000 g/mol. In addition to the usual structural units of polycarboxylic acid and polyalcohol, the polyester polyol also contains olefinic constituents, in particular the structural unit maleic anhydride.

However, the incorporation of such unsaturated polycarboxylic acids, or anhydrides, which reduce the free mobility of the segments of the polyester chain has the disadvantage that it is associated with an increase in the viscosity of the polyester polyols or polyester polyol mixtures that are used. The increased concentration of polar ester carbonyl functions as a result of the incorporation of maleic acid into the polyester chain, also has the same viscosity-increasing effect. The increased viscosity further restricts the usability of the polyester polyols, which are already relatively highly viscous per se.

In addition to these disadvantages, it was found in industrial practice that polyester polyols modified with unsaturated structural units in many cases yield coarsely divided dispersions. In fact, in most of these cases the dispersions contain particles visible to the naked eye and that are often difficult to filter.

The object of the present invention is, therefore, to provide an improved process for the preparation of polyester-based polymer polyols.

### SUMMARY OF THE INVENTION

It has now been found that the use of a small amount of polyesters composed of succinic acid (i.e. polysuccinate polyols) as a constituent of the polyester polyol leads to improved polyester polyol dispersions. In a further variation in accordance with the present invention, small amounts of polyester polyols pre-extended with polyisocyanates, and optionally also polyether polyols, to form OH-terminated prepolymers are advantageously used concomitantly.

Thus, the present invention is directed to polymer dispersions comprising at least one polyester polyol that contains one or more structural units derived from succinic acid (i.e. a “polysuccinate polyol”).

The present invention also provides a process for the preparation of the polymer dispersions. This process comprises free-radically polymerising (1) one or more olefinically unsaturated monomers, with (2) one or more polyester polyols that are free of olefinically unsaturated groups and that contain one or more structural units derived from succinic acid, and optionally, (3) one or more additional polyester polyols that are free of olefinically unsaturated groups and that are free of structural units derived from succinic acid.

### DETAILED DESCRIPTION OF THE INVENTION

The base polyester polyol used herein is prepared from components that do not contain olefinic constituents. Base polyester polyols are hydroxyl-end-group-containing polycondensation products of diols and dicarboxylic acids or their anhydrides or low molecular weight esters or semi-esters, preferably those with monofunctional alcohols such as methanol, ethanol, 1-propanol, 2-propanol, 1-butanol and 2-butanol.

Examples of suitable diols for the preparation of the base polyester polyols are ethylene glycol, 1,2-propanediol, 1,3-propanediol, 2-methyl-1,3-propanediol, 1,4-butanediol, 1,5-pentanediol, 3-methyl-1,5-pentanediol, 1,6-hexanediol, 1,8-octanediol, 1,10-decanediol, neopentyl glycol, diethylene glycol, triethylene glycol, tetraethylene glycol etc. Also suitable are polyether polyols having number-average molar masses of from 250 to 4,500 g/mol., and particularly those which contain predominantly units derived from 1,2-propylene oxide. In a corresponding manner, it is also possible to use as diols, the ether oligomers of butanediol, such as dibutylene glycol, tributylene glycol, or corresponding diols having number-average molar masses of from 240 to 3,000 g/mol. which are obtainable by ring-opening polymerisation of tetrahydrofuran. The corresponding compounds of 1,6-hexanediol, i.e. di- and tri-hexylene glycol, or oligomeric mixtures which can be obtained by azeotropic etherification of 1,6-hexanediol, are likewise suitable.

In addition, it is also possible to use concomitantly up to about 5 wt. % of polyols having a higher functionality. Such higher functionality polyols include, for example 1,1,1-trimethylolpropane, glycerol or pentaerythritol, as well as polypropylene oxide and polyethylene oxide polyols having number-average molar masses of from 250 to 4,500 g/mol. started therefrom.

As dicarboxylic acids without an olefin grouping, there may be used aliphatic and/or aromatic compounds, either individually or in a mixture. Examples which may be mentioned include: glutaric acid, adipic acid, pimelic acid, suberic acid, sebacic acid, phthalic acid, isophthalic acid, terephthalic acid, etc. In addition, it is also possible to use their anhydrides, and also their esters or semi-esters with low molecular weight, in particular monofunctional alcohols.

In an analogous manner, esters of cyclic hydroxylcarboxylic acids, and preferably those which can be prepared from ε-caprolactone, can also be used.

In a corresponding manner, polyesters of carbonic acid, that is to say polycarbonate polyols, may also be used or be used concomitantly. These polycarbonate polyols can be prepared by transesterification of dimethyl carbonate or diphenyl carbonate with diols and triols, as well as by transesterification with hydroxyl-terminal oligoester and oligoether diols having number-average molar masses of from 200 to 1,000 g/mol.

The polyester polyols suitable for use in accordance with the present invention have a mean hydroxyl functionality of from 1.8 to 3, preferably from 1.85 to 2.7, and most preferably from 1.9 to 2.5, and a number-average molar mass of from 1,000 to 5,000 g/mol., preferably from 1,300 to 4,800 g/mol., and most preferably from 1,600 to 4,500 g/mol.

If a plurality of polyester polyols are used, then the limits of the molar mass mentioned in the above paragraph relates to the polyester polyol mixture. In this case, it is of course also possible for the number-average molecular weight of at least one of the individual components to be outside the indicated limits, for example in the range from 450 to less than 1,000 g/mol.

Suitable for the polyester polyols herein which contain one or more structural units derived from succinic acid i.e. (polysuccinate polyols) there are those polyols having number-average molecular weights of from 250 to 4,000 g/mol. Preference is given to polyester polyols which contain as the carboxylic acid component predominantly (i.e. more than 50 wt. %, based on 100 wt. % of all carboxylic acids present) succinic acid. Particular preference is given to polyester polyols in which more than 80 wt. % of the structural units derived from carboxylic acids are derived from succinic acid. The polyester polyols may contain all the structural units listed hereinabove as structural components. In a preferred embodiment of the invention, a polyester polyol containing structural units derived predominantly from succinic acid (i.e. a polysuccinate polyol) is used in admixture with one or more polyester polyols which do not contain any structural units derived from succinic acid.

According to the present invention, the proportion of the polysuccinate polyol in all of the polyester polyol components is less than 50 wt. %, preferably less than 30 wt. %, and most preferably less than 10 wt. %. When incorporating succinic acid into the base polyester polyols, either by transesterification or direct esterification, the limits in respect of the composition apply correspondingly.

Preference is given further to the so-called OH-terminated prepolymers. These OH-terminated prepolymers are obtainable by reaction of the above-mentioned polysuccinate polyols in a molar excess, with one or more polyisocyanates. The molar ratios of isocyanate groups to hydroxyl groups (i.e. characteristic number or isocyanate index) are from 0 to 0.9, preferably from 0 to 0.7, and most preferably from 0.3 to 0.6.

Suitable polyisocyanates which may be used to prepare the OH-terminated prepolymers include, for example, both aliphatic and aromatic polyisocyanates such as, for example, hexamethylene diisocyanate, isophorone diisocyanate, 2,4- and 2,6-toluylene diisocyanate or mixtures thereof, as well as polyisocyanates from the diphenylmethyane diisocyanate group, and the three-ring and/or higher ring products derived by the phosgenation of aniline-formaldehyde condensation products. These three-ring and higher ring products are often referred to as polymethylene poly(phenylene polyisocyanate) or polymeric MDI (i.e. PMDI). Also suitable is naphthalene-1,5-diisocyanate.

Particularly preferred polyisocyanates are those polyisocyanates of the diphenylmethane series which contain amounts of so-called binuclear species (i.e. the 2,2′-, the 2,4′- and the 4,4′-isomers) of less than 50 wt. %. Binuclear species are also frequently referred to as monomers of MDI. These particularly preferred polyisocyanates have a mean functionality of at least 2.2.

The polysuccinate polyols are used in amounts such that the amount of the substances used for the modification, i.e. polysuccinate polyol or the OH-terminated prepolymer prepared therefrom, based on the reaction mixture as a whole, including the radically polymerisable vinyl monomers and any solvent, is from 0.05 to 15 wt. %.

Examples of suitable radically polymerisable vinyl monomers include styrene, alpha-methylstyrene, ethylstyrene, vinyltoluene, divinylbenzene, isopropylstyrene, chlorostyrene, butadiene, isoprene, pentadiene, acrylic acid, methacrylic acid, methacrylic acid methyl ester, vinyl acetate, acrylonitrile, methyl vinyl ketone or combinations of these compounds. Preference is given to the use of styrene, alpha-methylstyrene, acrylonitrile, methacrylonitrile, and methacrylic acid alkyl esters with C₁-C₃₀-alkyl radicals (e.g. methyl, ethyl, butyl, hexyl, dodecyl, etc.). Particular preference is given to styrene and acrylonitrile, with styrene preferably being used in an amount of more than 75 wt. %, and most preferably of more than 90 wt. %.

In accordance with the present invention, the amount of these radically polymerisable vinyl monomers which are to be used in the mixture as a whole, i.e. the degree of filling of the finished dispersion, is from 2 to 55 wt. %, preferably from 4 to 40 wt. %, and most preferably from 5 to 33 wt. %. The degree of filling can be adjusted by subsequent dilution with a second base polyester polyol.

In a preferred embodiment of the invention, there are used as the base polyester polyol a combination of two different polyester polyols which differ at least in respect of their number-average molecular weights. The polyester polyol having the smaller molecular weight is mixed in only when the free-radical polymerisation of the vinyl monomer in the mixture of the polyester polyol having the higher molecular weight and the modified polyester polyol is complete.

Free-radical initiators which are known per se are suitable to initiate the free-radical polymerisation process herein. Examples of initiators from the group of the azo initiators include alpha,alpha′-azo-2-methylbutyronitrile, alpha,alpha′-azo-2-heptonitrile, 1,1′-azo-1-cyclohexanecarbonitrile, dimethyl-alpha,alpha′-azo-isobutyrate, 4,4′-azo-4-cyanopentanoic acid, azo-bis(2-methylbutyronitrile), azo-bis-isobutyronitrile. Some examples from the group of the peroxides, persulfates, perborates, and percarbonates that may be mentioned by way of example include: dibenzoyl peroxide, acetyl peroxide, benzoyl hydroperoxide, tert.-butyl hydroperoxide, di-tert.-butyl peroxide, 2-ethylhexanoic acid tert.-butyl perester, diisopropyl peroxydicarbonate, etc.

The free-radical polymerisation is typically carried out in the presence of a solvent, but may also be carried out without a solvent. Examples of suitable solvents include: benzene, toluene, xylene, acetonitrile, hexane, heptane, dioxane, ethyl acetate, N,N-dimethylformamide, N,N-dimethylacetamide, etc. Benzene, xylene and toluene are preferred.

The present invention also provides polymer dispersions obtained by the processes of this invention. The products obtained are white dispersions which comprise a high molecular weight polymer or copolymer, a conventional polyester polyol that is solid or, preferably, liquid at room temperature, and a further modified polyester polyol which is necessary for phase stabilisation. They may have, for example, at a degree of filling of 25 wt. % polystyrene and an OH number of from 50 to 60, a range of viscosities of from 15,000 to 35,000 mPas at 25° C. and from 3,000 to 8,000 mPas at 50° C. The viscosity of the resultant polymer polyol is proportional to the viscosity of the base polyester polyol that is used to prepare the polymer polyol, and it is inversely proportional to the OH number of the base polyester polyol.

The polymer polyols prepared according to the invention are suitable for the production of polyurethanes, or polyurethane materials, and particularly for the production of microcellular polyurethane elastomers. Microcellular polyurethane elastomers such as these are known to be suitable in the manufacture of shoe soles. The present invention also provides shoe soles comprising the reaction product of the polymer dispersions according to the invention with polyisocyanates or polyisocyanate prepolymers.

Using the polymer dispersions according to the invention, it is possible to obtain polyurethanes which, compared with polyurethanes prepared without a polymer dispersion, have a greater hardness while having the same density. If it is also desired to keep the hardness as well as the density constant, it is possible when using the polymer dispersions according to the invention to work with a markedly reduced amount of polyisocyanate.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

A.) Base polyester polyols

B.) Preparation of modified polyester polyols

C.) Preparation of dispersions according to the invention

D.) Comparison examples

E.) Processing examples

### A.) Base Polyester Polyols A.1 through A.7

Base polyester polyols A.1 through A.7 were prepared and used in the working examples. These base polyester polyols were prepared as set forth below.

A.1. Polyether Ester Polyol

Adipic acid, ethylene glycol, butanediol, diethylene glycol and a bifunctional polyether polyol having a propylene oxide content of about 70% and an ethylene oxide content of about 30% and having an OH number of 28 mg KOH/g (Desmophen® L 2830, Bayer AG) in the weight ratio 36.53:5.19:9.53:8.67:28.97 were slowly heated to 200° C., with the elimination of water. When the formation of water had ceased, the mixture was cooled to 120° C. and catalysed with 180 mg of tin dichloride. The reaction mixture was slowly heated to 200° C. over the course of 4 hours under a water-jet vacuum, with additional water separating off. The mixture was left under these reaction conditions for a further 24 hours. Then the hydroxyl number of the resultant polyether ester polyol was determined as 39.1 mg KOH/g and the viscosity was 1070 mPas (at 75° C.).

A.2. Polyester Polyol

A polyester polyol based polyadipate that was prepared by reacting adipic acid and equimolar amounts of ethylene glycol and diethylene glycol. This polyester polyol had an OH number of about 56 mg KOH/g and a viscosity of about 520 mPas (75° C.).

A.3. Base Polyester Polyol Having a High Molecular Weight

2779 g (26.22 mol.) of diethylene glycol, 813 g (13.12 mol.) of ethylene glycol and 5452 g (37.12 mol.) of adipic acid were slowly heated to 200° C., with the elimination of water. When the formation of water had ceased, the mixture was cooled to 120° C. and catalysed with 180 mg of tin dichloride. The reaction mixture was slowly heated to 200° C. over the course of 4 hours under a water-jet vacuum, with additional water separating off. The mixture was left under these reaction conditions for another 24 hours. Then, the hydroxyl number of the resultant base polyester polyol was determined as 27.8 mg KOH/g and the acid number as 0.8 mg KOH/g.

A.4. Base Polyester Polyol Having a Low Molecular Weight

3177 g (29.97 mol.) of diethylene glycol, 932 g (15.03 mol.) of ethylene glycol and 5256 g (36 mol.) of adipic acid were slowly heated to 200° C., with the elimination of water. When the formation of water had ceased, the mixture was cooled to 120° C. and catalysed with 180 mg of tin dichloride. The reaction mixture was slowly heated to 200° C. over the course of 4 hours under a water-jet vacuum, with additional water separating off. The mixture was left under these reaction conditions for a further 24 hours. The resultant base polyester polyol was then analysed and found to have a hydroxyl number of 120.1 mg KOH/g and the acid number of 0.3 mg KOH/g.

A.5. Base Polyester Polyol Having a Low Molecular Weight

2628 g (24.79 mol.) of diethylene glycol, 1538 g (24.79 mol.) of ethylene glycol and 5970 g (40.89 mol.) of adipic acid were slowly heated to 200° C., with the elimination of water. When the formation of water had ceased, the mixture was cooled to 120° C. and catalysed with 180 mg of tin dichloride. The reaction mixture was slowly heated to 200° C. over the course of 4 hours under a water-jet vacuum, with additional water separating off. The mixture was left under these reaction conditions for a further 24 hours. The resultant base polyester polyol was then analysed and found to have a hydroxyl number of 98.1 mg KOH/g and an acid number of 0.3 mg KOH/g. The viscosity of the base polyester polyol was 210 mPas (at 75° C.).

A.6. Base Polyester Polyol Having a Low Molecular Weight

1208 g (11.4 mol.) of diethylene glycol, 1208 g (19.48 mol.) of ethylene glycol, 1208 g (13.42 mol.) of butanediol and 5840 g (40 mol.) of adipic acid were slowly heated to 200° C., with the elimination of water. When the formation of water had ceased, the mixture was cooled to 120° C. and catalysed with 180 mg of tin dichloride. The reaction mixture was slowly heated to 200° C. over the course of 4 hours under a water-jet vacuum, with additional water separating off. The mixture was left under these reaction conditions for a further 24 hours. The resultant base polyester polyol was then analysed and was found to have a hydroxyl number of 60.1 mg KOH/g and an acid number of 0.7 mg KOH/g. Viscosity of this base polyester polyol was 8930 mPas (at 25° C.).

A.7. Polyester Polyol

A polyester polyol based on polyadipate. This polyester polyol was prepared from adipic acid and a mixture of ethylene glycol and butylene glycol. The resultant polyester polyol was characterized by an OH number of about 56 mg KOH/g and a viscosity of about 620 mPas (at 75° C.).

### B.) Preparation of Modified Polyols

Modified polyols B.1 through B.8 were prepared and used in the working examples as described below. The following components were used in the preparation of these modified polyols:
Isocyanate A: a polyisocyanate of the diphenylmethane series, having an NCO group content of about 33.5 and a functionality of about 2.9; also characterized by a polymeric content of about 56% and a monomeric content of about 44%. Of the monomeric content, about 39 to 40% is the 4,4′-isomer of MDI and the balance is a mixture of the 2,2′- and the 2,4′-isomers of MDI.
Isocyanate B: diphenylmethane diisocyanate having an NCO group content of about 33.5%, a functionality of about 2, and containing about 99% by wt. of the 4,4′-isomer and the balance being a mixture of the 2,2′- and the 2,4′-isomers.
Polyether Polyol A: a trimethylolpropane initiated polyether of polypropylene oxide having an OH number of 28 mg KOH/g

These modified polyols were prepared as set forth below.

B.1. Preparation of a Polysuccinate Polyol

1122 g (7.48 mol.) of triethylene glycol and 578 g (5.78 mol.) of succinic anhydride were reacted, with tin dichloride catalysis (40 mg), in a melt polycondensation at 200° C. with the elimination of water, at the end in vacuo. The OH number of the resultant polysuccinate polyol was 116.5 mg KOH/g; and the acid number was 0.2 mg KOH/g.

B.2. Preparation of an OH Prepolymer

481.5 g of the polysuccinate polyol prepared in B.1. were reacted at 115° C. for 3 hours with 62.5 g of Isocyanate A until an NCO content of 0% NCO was achieved. The resultant OH-terminated prepolymer had an OH number of 67.5 mg KOH/g.

B.3. Preparation of an OH Prepolymer

481.5 g of the polysuccinate polyol prepared in B.1. were reacted for one hour at 80° C. and for a further two hours at 100° C. with 62.5 g of Isocyanate B until an NCO content of 0% NCO was achieved. The resultant OH-terminated prepolymer had a viscosity of 2240 mPas (75° C.) and an OH-number of 51,7 mg KOH/g.

B.4. Preparation of an OH Prepolymer

463 g of the polyadipate polyol prepared in A.4. were reacted for one hour at 80° C. and for a further two hours at 100° C. with 62.5 g of Isocyanate B until an NCO content of 0% NCO was achieved. The viscosity was determined as 2680 mPas (75° C.). The resultant OH-terminated prepolymer had an OH-number of 53,5 mg KOH/g.

B.5. Preparation of an OH Prepolymer

463 g of the polyadipate polyol prepared in A.4. were reacted for one hour at 80° C., then for one hour at 100° C., and then for a further two hours at 100° C., with 62.5 g of Isocyanate B until an NCO content of 0% NCO was achieved. The viscosity was determined as 2950 mPas (75° C.). The resultant OH-terminated prepolymer had an OH-number of 56.9 mg KOH/g.

B.6. Preparation of a Polyether Polyol Containing Acrylate End Groups

144 g of acrylic acid methyl ester were slowly added at 50° C. to 4,000 g of Polyether Polyol A, and 1 g of titanium tetraisobutylate with methanol being removed from the reaction mixture at elevated temperature. The resultant polyether polyol containing acrylate end groups had an OH number of 21 mg KOH/g; and a viscosity of 1700 mPas at 25° C.

B.7. Preparation of a Polyester Polyol Containing Maleic Acid

1,148 g (7.65 mol.) of triethylene glycol and 583 g (5.95 mol.) of maleic anhydride, as well as 0.5 g of hydroquinone, were reacted, with tin dichloride catalysis (40 mg), in a melt polycondensation at 200° C. with the elimination of water, at the end in vacuo. The resultant polyester polyol containing maleic acid had an OH number of 112 mg KOH/g; and the acid number was determined as 0.9 mg KOH/g.

B.8. Preparation of a Polyadipate Containing Maleic Acid

5.548 g (38 mol.) of adipic acid, 196 g (2 mol.) of maleic anhydride, 1,728 g (27.87 mol.) of ethylene glycol and 1,728 g (16.3 mol.) of diethylene glycol were reacted, with tin dichloride catalysis (200 mg), in a melt polycondensation at 200° C. with the elimination of water, at the end in vacuo. The resultant polyol had an OH number of 55 mg KOH/g; and an acid number was determined as 0.2 mg KOH/g. This polyol had a viscosity of 2550 mPas at 25° C.

### C.) Preparation of Polymer Dispersions According to the Invention

C.1. Preparation of a Polymer Dispersion from OH Prepolymer (B.2.)

476 g of polyester polyol A.2. were stirred with 8.7 g of the OH prepolymer B.2., 100 g of toluene and 1 g of azo-bis(2-methylbutyronitrile). A weak stream of nitrogen was passed through the solution for 20 minutes, 80 g of styrene were added, and the mixture was heated to 80° C. over the course of 30 minutes, with stirring. After 20 minutes at 80° C., the temperature was raised to 120° C. over the course of a further 30 minutes.

A previously prepared solution of 600 g of polyester polyol A.2., 14.3 g of the OH prepolymer B.2., 200 g of toluene, 5.4 g of azo-bis(2-methylbutyronitrile) and 430 g of styrene were added in metered amounts to the above mixture, over the course of 2 hours, at an initial speed of 300 rpm, with the speed being increased to 350 rpm after 20 minutes and to 400 rpm after a further 40 minutes. When the metered addition was complete, the mixture was allowed to react for 5 minutes.

A further previously prepared solution of 38 g of polyester polyol A.2., 3.5 g of the OH prepolymer B.2., 50 g of toluene and 0.6 g of azo-bis(2-methylbutyro-nitrile) was then added in metered amounts to the above mixture, over the course of 30 minutes. When the addition was complete, the mixture was allowed to react for 2 hours at 120° C.

The resultant mixture was worked up by applying a water-jet vacuum to the reaction mixture to largely remove the solvent and any unreacted styrene. For completion, an oil-pump vacuum was applied, with both styrene and toluene being removed to the greatest possible extent after 2 hours at 0.5 mbar.

The resultant polymer dispersion could be filtered through a 200 μm sieve, was phase-stable and had a viscosity of 18,600 mPas at 25° C., or 3690 mPas at 50° C.

The degree of filling, i.e. the solids content, in the polymer dispersion was about 26.7 wt. %, and the OH number was 54 mg KOH/g.

C.2. Preparation of a Polymer Dispersion from OH Prepolymer (B.2.)

Substances used initially:

476 g of polyester polyol A.2.

3.0 g of OH prepolymer B.2.

100 g of toluene

80 g of styrene

0.6 g of azo-bis(2-methylbutyronitrile)

66 g of 1,4-butanediol

The above substances were placed in a reaction vessel at 115° C. As described above in Example C.1., the following mixtures were added in metered amounts:

Metered addition 1:

600 g of polyester polyol A.2.

14.3 g of OH prepolymer B.2.

200 g of toluene

533 g of styrene

5.4 g of azo-bis(2-methylbutyronitrile)

Metered addition 2:

38 g of polyester polyol A.2.

3.5 g of OH prepolymer B.2.

50 g of toluene

0.6 g of azo-bis(2-methylbutyronitrile)

The resultant polymer dispersion could be filtered through a 200 μm sieve, was phase-stable and had a viscosity of 18,600 mPas at 25° C., or 3850 mPas at 50° C. The degree of filling, i.e. the solids content, in the polymer dispersion was about 32 wt. %, and the OH number was 69.6 mg KOH/g.

C.3. Preparation of a Polymer Dispersion from OH Prepolymer (B.2.)

Substances used initially:

476 g of polyester polyol A.2.

3.0 g of OH prepolymer B.2.

100 g of toluene

80 g of styrene

0.6 g of azo-bis(2-methylbutyronitrile)

66 g of 1,4-butanediol

The above substances were placed in a reaction vessel at 115° C. As described above in Example C.1., the following mixtures were added in metered amounts:

Metered addition 1:

600 g of polyester polyol A.2.

14.3 g of OH prepolymer B.2.

200 g of toluene

738 g of styrene

5.4 g of azo-bis(2-methylbutyronitrile)

Metered addition 2:

38 g of polyester polyol A.2.

3.5 g of OH prepolymer B.2.

50 g of toluene

0.6 g of azo-bis(2-methylbutyronitrile)

The resultant polymer dispersion could be filtered through a 200 μm sieve, was phase-stable and had a viscosity of 32,100 mPas at 25° C., or 7410 mPas at 50° C. The degree of filling, i.e. solids content, in the polymer dispersion was about 40 wt. %, and the OH number was about 68.9 mg KOH/g.

C.4. Preparation of a Polymer Dispersion from Polysuccinate Polyol (B.1.)

Substances used initially:

476 g of polyester polyol A.3.

3.0 g of polysuccinate polyol B.1.

100 g of toluene

80 g of styrene

1 g of azo-bis(2-methylbutyronitrile)

The above substances were placed in a reaction vessel at 115° C. As described above in Example C.1., the following mixtures were added in metered amounts:

Metered addition 1:

600 g of polyester polyol A.3.

14.3 g of polysuccinate polyol B.1.

200 g of toluene

800 g of styrene

6.4 g of azo-bis(2-methylbutyronitrile)

Metered addition 2:

38 g of polyester polyol A.3.

4 g of polysuccinate polyol B.1.

100 g of toluene

0.6 g of azo-bis(2-methylbutyronitrile)

Prior to filtration, the OH number of the mixture was determined to be 18.4 mg KOH/g. This mixture was mixed with 1,127 g of base polyester polyol A.4.

The resulting dispersion could be filtered through a 200 μm sieve, was phase-stable and had a viscosity of 27,200 mPas at 25° C., or 5620 mPas at 50° C. The degree of filling, i.e. solids content, of this polymer dispersion was about 24.3 wt. %, and the OH number was about 58.3 mg KOH/g.

### D.) Comparison Examples

D.1. Preparation of a polymer polyol from OH prepolymer B.3.:

Substances used initially:

476 g of polyester polyol A.3.

3.0 g of OH prepolymer B.3.

100 g of toluene

80 g of styrene

1 g of azo-bis(2-methylbutyronitrile)

The above substances were placed in a reaction vessel at 115° C., and the following mixtures were added in metered amounts. Additional details are as set forth above in Example C.1.), except as otherwise noted:

Metered addition 1:

600 g of polyester polyol A.3.

14.3 g of OH prepolymer B.3.

200 g of toluene

800 g of styrene

6.4 g of azo-bis(2-methylbutyronitrile)

Metered addition 2:

38 g of polyester polyol A.3.

4 g of OH prepolymer B.3.

100 g of toluene

0.6 g of azo-bis(2-methylbutyronitrile)

Prior to filtration, the OH number of the mixture was determined to be 18 mg KOH/g. This mixture was then mixed with 1,136 g of polyester polyol A.4. The resulting dispersion could not be filtered.

D.2. Preparation of a Polymer Dispersion from OH Prepolymer B.4. (i.e. an OH-Terminated Prepolymer Based on Polyadipate)

Substances used initially:

476 g of polyester polyol A.3.

3.0 g of OH prepolymer B.4.

100 g of toluene

80 g of styrene

1 g of azo-bis(2-methylbutyronitrile)

The above substances were placed in a reaction vessel at 115° C. As described above in Example C.1., the following mixtures were added in metered amounts:

Metered addition 1:

600 g of polyester polyol A.3.

21 g of OH prepolymer B.4.

200 g of toluene

800 g of styrene

6.4 g of azo-bis(2-methylbutyronitrile)

Metered addition 2:

38 g of polyester polyol A.3.

4 g of OH prepolymer B.4.

100 g of toluene

0.6 g of azo-bis(2-methylbutyronitrile)

Prior to filtration, the OH number of the mixture was determined to be 17.7 mg KOH/g. This mixture was then mixed with 1,123 g of polyester polyol A.4.

The resultant dispersion could be filtered through a 200 μm sieve with difficulty. A considerable amount of filtration residue remained, so that the filtration behavior was considered deficient. However, the dispersion was phase-stable and had a viscosity of 30,100 mPas at 25° C., or 5550 mPas at 50° C. The degree of filling, i.e. the solids content, of the resultant dispersion was about 24.1 wt. %, and the OH number was about 57.7 mg KOH/g.

D.3. Preparation of a Polymer Dispersion from OH Prepolymer B.5. (i.e. an OH-Terminated Prepolymer Based on Polyadipate):

Substances used initially:

476 g of polyester polyol A.3.

3.0 g of OH prepolymer B.5.

100 g of toluene

80 g of styrene

1 g of azo-bis(2-methylbutyronitrile)

The above substances were placed in a reaction vessel at 115° C. As described above in Example C.1., the following mixtures were added in metered amounts:

Metered addition 1:

600 g of polyester polyol A.3.

21 g of OH prepolymer B.5.

200 g of toluene

800 g of styrene

6.4 g of azo-bis(2-methylbutyronitrile)

Metered addition 2:

38 g of polyester polyol A.3.

4 g of OH prepolymer B.5.

100 g of toluene

0.6 g of azo-bis(2-methylbutyronitrile)

Prior to filtration, the OH number of the dispersion was determined to be 18 mg KOH/g. This dispersion was then mixed with 1,123 g of polyester polyol A.4.

The resultant dispersion could be filtered through a 200 μm sieve with difficulty. A considerable amount of filtration residue remained, so that the filtration behavior was considered deficient. However, the dispersion was phase-stable and had a viscosity of 26,800 mPas at 25° C., or 5340 mPas at 50° C. The degree of filling, i.e. the solids content, of the dispersion was about 23.9 wt. %, and the OH number was about 57.7 mg KOH/g.

D.4. Preparation of a Polymer Dispersion from Polyether Polyol B.6. (i.e. a Polyether Polyol Containing Acrylate Groups):

Substances used initially:

476 g of polyester polyol A.7.

8.7 g of modified polyol B.6.

200 g of toluene

80 g of styrene

0.6 g of azo-bis(2-methylbutyronitrile)

The above substances were placed in a reaction vessel at 115° C. As described above in Example C.1., the following mixtures were added in metered amounts:

Metered addition 1:

538 g of polyester polyol A.7.

43 g of modified polyol B.6.

200 g of toluene

738 g of styrene

5.4 g of azo-bis(2-methylbutyronitrile)

Metered addition 2:

100 g of polyester polyol A.7.

10.4 g of modified polyol B.6.

50 g of toluene

The resultant dispersion was not stable; i.e. two separate phases formed. The degree of filling, i.e. the solids content, of this dispersion was about 40 wt. %.

D.5. Preparation of a Polymer Dispersion from Polyester Polyol B.7. (i.e. a Polyester Polyol Containing Maleic Acid Groups)

Substances used initially:

476 g of polyester polyol A.4.

8.7 g of modified polyol B.7.

200 g of toluene

80 g of styrene

0.6 g of azo-bis(2-methylbutyronitrile)

33 g of isopropanol

The above substances were placed in a reaction vessel at 115° C. As described above in Example C.1., the following mixtures were added in metered amounts:

Metered addition 1:

600 g of polyester polyol A.4.

43 g of modified polyol B.7.

200 g of toluene

533 g of styrene

5.4 g of azo-bis(2-methylbutyronitrile)

Metered addition 2:

38 g of polyester polyol A.4.

10.4 g of modified polyol B.7.

50 g of toluene

0.6 g of azo-bis(2-methylbutyronitrile)

The resulting dispersion could not be filtered.

D.6. Preparation of a Polymer Dispersion from Polyol B.8., i.e. a Polyadipate Containing Maleic Acid Group

Substances used initially:

830 g of polyester polyol A.6.

50 g of toluene

The above substances were placed in a reaction vessel at 120° C. As described above in Example C.1., the following mixture was added in metered amounts:

Metered addition:

353 g of polyester polyol A.6.

62 g of modified polyol B.8.

200 g of toluene

523 g of styrene

13 g of azo-bis(2-methylbutyronitrile)

The reaction product could not be filtered.

### E.) Processing Examples

For the production of polyurethane test specimens, the respective isocyanate components (identified below) were mixed at 40° C. in a low-pressure processing machine (i.e. PSA 95, Klockner DESMA Schuhmaschinen GmbH) with the respective polyol components (identified below) which contained a polymer dispersion at 45° C. The mixture was introduced into an aluminium mold (size 200*200*10 mm) adjusted to a temperature of 50° C., the mold was closed, and after 4 minutes the elastomer was removed from the mold.

After 24 hours' storage, the hardness of the elastomer sheets so produced was measured according to DIN 53 505 using a Shore A type durometer.

E1. Preparation of a Polyurethane Elastomer:

Composition of the Polyol Component:

71.00 wt. % polyester polyol A.2.

15.00 wt. % polymer dispersion C.1.

11.45 wt. % ethanediol

0.80 wt. % triethanolamine

0.45 wt. % diazabicyclo[2.2.2]octane

1.10 wt. % water

0.20 wt. % cell stabilizer (Dabco® DC 193, Air Products)

An NCO prepolymer having an NCO content of 19.3% by wt. and comprising the reaction product of diphenylmethane diisocyanate and a polyester polyol, was processed with the polyol component as described. The mixing ratio of the polyol component to the isocyanate component was 100:122 parts by weight. A free-rise foam that had a free-foam density of 140 kg/m³ was prepared from one sample. Test specimens as described in the general process above were prepared from the remaining isocyanate prepolymer component and polyol component. These test specimens had a molded-body density of 350 kg/m³ and could be removed from the mold after 4 minutes. The Shore A hardness of these test specimens was 51.

E2. Preparation of a Polyurethane Elastomer

Composition of the Polyol Component:

50.55 wt. % polyester polyol A.2.

35.50 wt. % polymer dispersion C.1.

11.40 wt. % ethanediol

0.80 wt. % triethanolamine

0.45 wt. % diazabicyclo[2.2.2]octane

1.10 wt. % water

0.20 wt. % cell stabiliser (Dabco® DC 193, Air Products)

An NCO prepolymer having an NCO content of 19.3 wt. % and comprising the reaction product of diphenylmethane diisocyanate and a polyester polyol was processed with the polyol component as described. The mixing ratio of the polyol component to the isocyanate component was 100:120 parts by weight. A free-rise foam that had a free-foam density of 153 kg/m³ was prepared from one sample. Test specimens as described in the general process above were prepared from the remaining isocyanate prepolymer component and polyol component. These test specimens had a molded-body density of 350 kg/m³ and could be removed from the mold after 4 minutes. The Shore A hardness of these test specimens was 56.

These Examples show that elastomers prepared with increasing quantities of the polymer dispersions according to the present invention result in an increase in hardness, while the density remains unchanged. At a constant amount of ethanediol, an increase in the amount of the polyol dispersion according to the invention in the polyol component, at a virtually identical mixing ratio with the polyisocyanate component (100:120 or 100:122), leads to materials having a hardness increased by 5 Shore A units (56 instead of 51).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polymer dispersion comprising at least one polyester polyol that contains one or more structural units derived from succinic acid.

2. A process for the preparation of polymer dispersions comprising free-radically polymerising
(1) one or more olefinically unsaturated monomers, with
(2) one or more polyester polyols that are free of olefinically unsaturated groups and that contain one or more structural units derived from succinic acid, and, optionally,
(3) one or more polyester polyols that are free of olefinically unsaturated groups and do not contain structural units derived from succinic acid.

3. A process for the preparation of polymer dispersions comprising free-radically polymerising
(1) one or more olefinically unsaturated monomers, with
(4) one or more OH-terminated prepolymers comprising the reaction product of
(a) one or more polyester polyols containing structural units derived from succinic acid, with
(b) one or more aromatic polyisocyanates of the diphenylmethane group wherein the total monomer content is less than 50% by wt., and, optionally,
(2) one or more polyester polyols that are free of olefinically unsaturated groups and do not contain structural units derived from succinic acid.

4. The process of claim 2, wherein (1) said one or more olefinically unsaturated monomers are selected from the group consisting of styrene, alpha-methylstyrene, ethylstyrene, vinyltoluene, divinylbenzene, isopropylstyrene, chlorostyrene, butadiene, isoprene, pentadiene, acrylic acid, methacrylic acid, methacrylic acid methyl ester, vinyl acetate, acrylonitrile, methyl vinyl ketone and mixtures thereof.

5. The process of claim 3, wherein (1) said one or more olefinically unsaturated monomers are selected from the group consisting of styrene, alpha-methylstyrene, ethylstyrene, vinyltoluene, divinylbenzene, isopropylstyrene, chlorostyrene, butadiene, isoprene, pentadiene, acrylic acid, methacrylic acid, methacrylic acid methyl ester, vinyl acetate, acrylonitrile, methyl vinyl ketone and mixtures thereof.

6. The process of claim 2, in which one or more polycarbonate polyols is additionally present.

7. The process of claim 3, in which one or more polycarbonate polyols is additionally present.

8. A polymer dispersion comprising the free-radical polymerization product of:
(1) one or more olefinically unsaturated monomers, with
(2) one or more polyester polyols that are free of olefinically unsaturated groups and contain one or more structural units derived from succinic acid, and, optionally,
(3) one or more polyester polyols that are free of olefinically unsaturated groups and do not contain structural units derived from succinic acid.

9. A polymer dispersion comprising the free-radical polymerization product of:
(1) one or more olefinically unsaturated monomers, with
(4) an OH-terminated prepolymer that comprises the reaction product of:
(a) one or more polyester polyols that are free of olefinically unsaturated groups and that contain one or more structural units derived from succinic acid, with
(b) one or more aromatic polyisocyanates of the diphenylmethane group wherein the total monomer content is less than 50% by wt., and, optionally,
(3) one or more polyester polyols that are free of olefinically unsaturated groups and do not contain structural units derived from succinic acid.

10. In a process for the preparation of polyurethanes comprising reacting one or more polyisocyanates with one or more isocyanate-reactive components, the improvement wherein said isocyanate-reactive component comprises the polymer dispersion of claim 1.

11. In a process for the preparation of polyurethanes comprising reacting one or more polyisocyanates with one or more isocyanate-reactive components, the improvement wherein said isocyanate-reactive component comprises the polymer dispersion of claim 8.

12. A microcellular polyurethane elastomer comprising the reaction product of one or more polyisocyanates with one or more isocyanate-reactive components, the improvement wherein said isocyanate-reactive component comprises the polymer dispersion of claim 1.

13. A microcellular polyurethane elastomer comprising the reaction product of one or more polyisocyanates with one or more isocyanate-reactive components, the improvement wherein said isocyanate-reactive component comprises the polymer dispersion of claim 8.
